(19) United States
(12) Patent Application Publication
(10) Pub. No.: US 2015/0122555 A1
(43) Pub. Date: May 7, 2015

(54) PORTABLE AND CONFIGURABLE LOW-PROFILE SCALE

(71) Applicant: LILYPAD SCALES, INC., Arlington, MA (US)

(72) Inventors: Amos Meeks, Arlington, MA (US); Molly Farison, Arlington, MA (US)

(73) Assignee: LILYPAD SCALES, INC., Arlington, MA (US)

(21) Appl. No.: 14/533,640

(22) Filed: Nov. 5, 2014

Related U.S. Application Data
(60) Provisional application No. 61/962,350, filed on Nov. 6, 2013.
(60) Provisional application No. 61/998,279, filed on Jun. 24, 2014.

(51) Int. Cl. G01G 21/22; G01G 19/44

(52) U.S. Cl. CPC G01G 21/22; G01G 19/44
USPC 177/126

(57) ABSTRACT

A scale for measuring the weight of a subject associated with a personal mobility system. The scale includes a sheet sized to receive the subject and at least a portion of the personal mobility system, a plurality of weighing pads separate from and selectively engageable with the sheet in a pattern corresponding to either the subject or a portion of the personal mobility device, and a display device in communication with the weighing pads to display a weight either of the subject or the subject and personal mobility system.

### RELATED APPLICATIONS

This application is based on and claims the benefit of U.S. Provisional Patent Application No. 61/998,279 filed on Jun. 24, 2014, and U.S. Provisional Patent Application No. 61/962,350 filed on Nov. 6, 2013, the entire disclosures of which are hereby incorporated herein by reference.

### BACKGROUND

The disclosure relates generally to scales arranged for use with personal mobility systems, such as wheelchairs.

While most people have easy access to a scale that will accurately measure their weight, many people who use wheelchairs do not enjoy this luxury. Wheelchair users have mainly two types of options for measuring their weight and neither are easy to use or convenient.

First, large platform scales exist for weighing wheelchair users. However, these scales are large, heavy, and expensive. This keeps their use primarily to large hospitals that have the money and space to invest in such resources. Even if an individual wheelchair user had the money to afford buying one, such scales do not fit well in a home. Thus, while these scales are theoretically easy to use, as the wheelchair user can simply roll on and press a button, they cannot be adopted by the wheelchair-using population as a weighing solution for home use.

Second, systems are available that replace the large structure described above with a plurality of weighing pads that are designed to be aligned with each wheel of the chair and, together, weigh the user. By using separate wireless battery-powered weighing pads for each wheel, the systems are far lighter, smaller, and more portable than large platform scales. For example, such systems can be reasonably carried in a suitcase. However, these scale systems must be specially configured to match each object it is weighing, and each time it is transported and then used again, it must be assembled and configured. This poses a large obstacle for individuals with disabilities, as the process of setting up the scale is difficult and laborious, and many wheelchair users may be unable to do it without assistance, which keeps them from using such a scale independently. Even if they do have assistance, the need to set up the scale for every individual use requires extra labor. Such scales can also be extremely expensive and cost more than some large, bulky platform scales.

Therefore, a need exists for a cost effective and easy to use weight measuring scale for wheelchair users.

### BRIEF SUMMARY

A scale system is disclosed that addresses the above shortcomings. The system may include a sheet of material on which at least one pad is placed. The pad's bottom surface contacts the sheet of material, and its top surface is shaped to hold a peg or wheel. Weight measurements from the pads are transferred to a readout for user display.

In one aspect, a scale is provided for measuring the weight of a subject associated with a personal mobility system. The scale includes a sheet sized to receive the subject and at least a portion of the personal mobility system, a plurality of weighing pads separate from and selectively engageable with the sheet in a pattern corresponding to either the subject or a portion of the personal mobility device, and a display device in communication with the weighing pads to display a weight either of the subject or the subject and personal mobility system.

In another aspect, a weighing pad is provided for use in a portable, adjustable, scale system including a plurality of the weighing pads to determine a weight of a subject associated with a personal mobility system and communicate the weight to a display device. The weighing pad includes an electronics housing, a controller arranged within the electronics housing and configured to communicate with the display device, and a load sensor in communication with the controller. A column is coupled to the electronics housing and is arranged to substantially center the subject or a portion of the subject and the personal mobility system the over the load sensor. A ramp is coupled to the column and arranged to facilitate rolling access to the column. An attachment element is arranged to selectively couple the weighing pad to the sheet.

In another aspect, the invention provides a scale for measuring the weight of a subject sitting in a four-wheel wheelchair. The scale includes a sheet of flexible material arranged to lay flat on a floor surface and be manipulated into a storage arrangement, and four weighing pads separate from and selectively engageable with the sheet in a pattern corresponding to the four wheels of the wheelchair. Each of the weighing pads is independent of the other weighing pads and includes an electronics housing, a controller arranged within the electronics housing, a load sensor in communication with the controller, a column coupled to the electronics housing, arranged above the load sensor, and configured to substantially center one of the wheels over the load sensor, a ramp coupled to the column and arranged to facilitate rolling access to the column, and an attachment element arranged to releasably couple the weighing pad to the sheet. The scale further includes a display device that is in communication with the controllers of the weighing pads to display a weight of the subject and the wheelchair.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF DRAWINGS

The disclosure will be better understood and features, aspects and advantages other than those set forth above will become apparent when consideration is given to the following detailed description thereof. Such detailed description makes reference to the following drawings.

FIG. 1 is a photo of a personal mobility system, in the form of a wheelchair, and user weighing himself on a scale including four pads according to the present disclosure.

FIG. 2 is a pictorial view of the scale of FIG. 1.

FIG. 3 is a pictorial view of one of the pads of the scale of FIG. 1.

FIG. 4 is a side view of the pad of FIG. 3.

FIG. 5 is a pictorial view of an adjustable width pad according to another aspect of the disclosure.

FIG. 6 is a top view of a pattern used to arrange the pads on the scale of FIG. 1.

FIG. 7 is a pictorial view of another pad according to the disclosure.

FIG. 8 is a pictorial view of the pad of FIG. 7 with spacers installed.

FIG. 9 is a front view of a display device according to one embodiment of the disclosure.

FIG. 10 is an operational flowchart illustrating operation of the scale of FIG. 1.

FIG. 11 is a pictorial view of a placeholder that may be used with the scale of FIG. 1 for conveniently attaching the pads.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

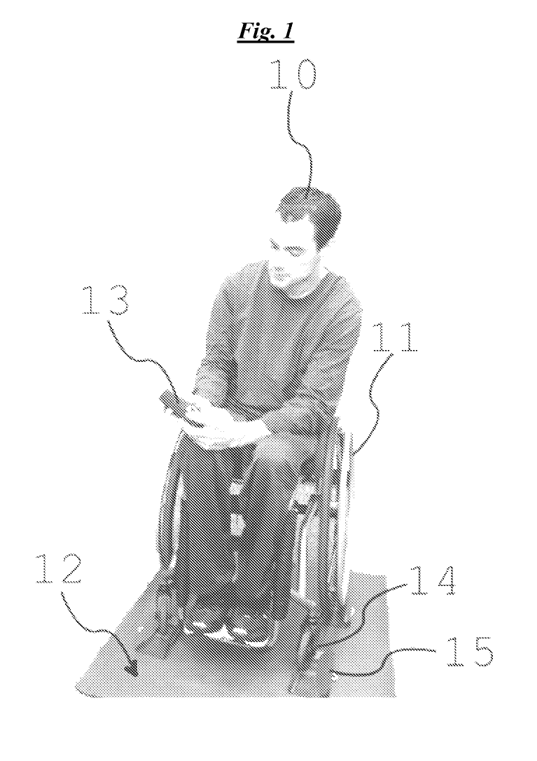

FIG. 1 shows a subject in the form of a user 10 sitting in a personal mobility system, illustrated as a wheelchair 11, that acts as the platform on top of a portable, configurable low-profile scale 12, looking at a display device 13 to read his weight. That is, personal mobility systems may include a variety of systems including crutches, walkers, wheelchairs, scooters, and the like. The user 10 might be a person with limited mobility, either walking, using crutches or a walker, or using a wheelchair. In other words, the wheelchair 11 may be replaced with another personal mobility system (e.g., crutches, a walker, a scooter, and so on) and the scale 12 configured to accurately measure the weight of the subject. To this end, reference to a wheelchair is for illustrative purposes only and can be substituted with other personal mobility systems. In other arrangements, the subject may be an animal or an object. The user 10 may use the scale 12 independently or with assistance.

While typical scales have some kind of platform built in, the inventive scale 12 makes use of the personal mobility system or assistance device, such as wheelchair 11, to provide the platform. By removing the often bulky and heavy platform of typical scales, the scale 12 is made more portable and less expensive while still being easy to use by users 10 with a readily available platform (e.g., wheelchair 11). The platform could be anything that supports itself with legs or wheels such that some or all of the legs or wheels fit onto a weighing pad 15. Possible platforms include a wheelchair 11 with wheels 14, a large sheet of sturdy material with pegs (i.e., a portable platform), a chair, a bed, a table, a walker with or without a seat, or a vehicle. Because the scale 12 is designed to be easily configured by the user 10, the same scale 12 can be easily used with a variety of platforms by rearrangement of the pads 15.

The display device 13 can be wireless or wired and it can be a device that comes with the scale 12, a phone, a computer, or any other device with the capability to receive and display information. A display device 13 which is wireless is preferred because long wires can tangle or interfere with the use of the scale 12. The display device 13 can have a visual display or it can have an audio output. Having both a visual and an audio output provides the advantage of being accessible to those with hearing impairments and those with visual impairments. Having the output on a display device 13 which is wireless is particularly advantageous for wheelchair users or others with a physical disability as it allows them to use the scale 12 without needing to look down at the scale 12, which may be difficult to do around a wheelchair 11, or may be difficult if use of the neck and upper body is impaired. A display device 13 which is wireless also allows the user 10 to use the scale 12 while moving their wheelchair 11 using their hands to push the wheels 14 or an electric system controller such as a joystick by not requiring the use of the hands to transport it, as it can be placed in the lap or mounted onto the wheelchair 11.

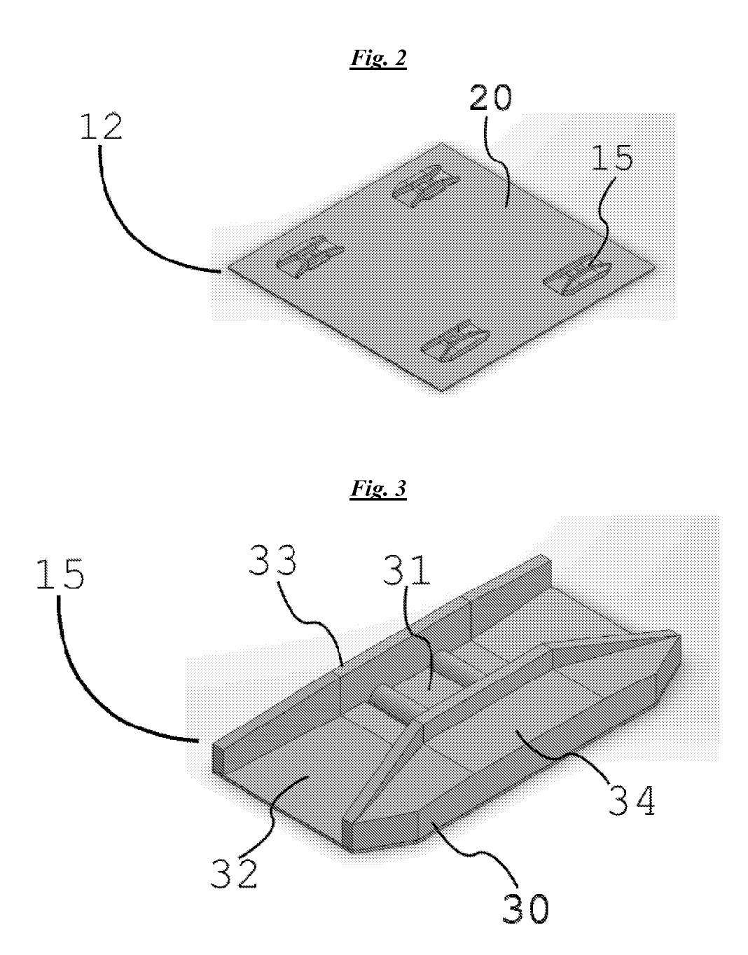

Turning to FIG. 2, the illustrated scale 12 includes four weighing pads 15 on a sheet of material 20. The scale 12 may have any number of pads 15, and these pads 15 may be placed in any configuration on the sheet 20. The configuration will be chosen to match the desired platform. For example, the scale 12 can be configured for a typical manual wheelchair 11 with four pads 15 placed on the sheet 20 such that one pad 15 is directly under each wheel 14 during use.

As shown in FIG. 3, each pad 15 includes a plastic housing 30 that encases the inner parts of the pad 15 and protects them from moisture, debris, and force. The housing 30 can be made of any sufficiently rigid material, such as ABS, PVC, or PP plastics, such that it does not break or significantly bend under the forces applied by the user 10 and platform.

The housing includes a column 31 that transfers the load of the user 10 from the platform to the inner parts of the pad 15 where that load is measured. The column 31 may be shaped to fit the wheels 14, pegs, or legs of the wheelchair 11 or platform to help center the load over the column 31, which can increase the accuracy of many weighing methods, especially pneumatic weighing methods. The column 31 design depicted is one example of a design that will hold a wheel 14 in place over the column 31 without allowing it to roll while also centering the wheel 14 over the column 31. This makes it easier for the user 10 to get the wheels 14 of the wheelchair 11 in the right place on the scale 12, and it increases the accuracy by centering the load. The column 31 can be made out of any rigid material that can hold the load while remaining intact, including wood, metal, or plastic.

The housing further includes, ramps 32 that assist the user 10 in rolling or otherwise moving the platform onto the column 31 of the pad 15. The ramps 32 can be a part of the housing 30, or they could be a separate part made of a similarly rigid material that is able to withstand the weight of the subject being weighed (e.g., the user 10). The ramps 32 could be permanently removable, removable and easily reattached to the housing 30, or entirely absent if unnecessary, for example if being used with a platform that does not roll, like a chair or static bed, or if the pad is low enough that the ramps 32 are not necessary. Having removable or absent ramps 32 provides the advantage of lowering the weight and bulk of the pad 15 when used in situations where the ramps 32 are not necessary.

The housing 30 can be specifically designed to aid in the use of the scale 12 with different platforms. For example, it may have guiding ridges 33 which can help direct the wheels 14 of the wheelchair 11 properly over the column 31.

An electronics housing 34 can be contained under any part of the pad 15, such as the ramp 32, guide ridges 33, or the column 31, or it could be entirely separate.

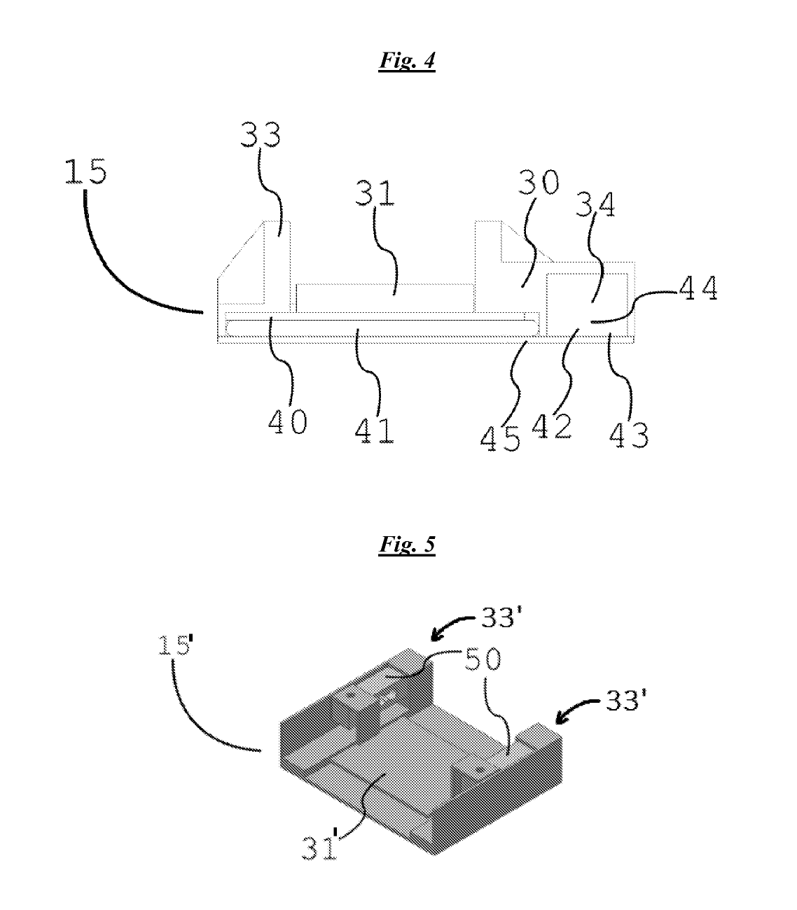

The housing 30 also includes an attachment element 45 for attaching to the sheet 20, as shown in FIG. 4. The attachment element 45 can take the form of holes into which a push rivet or adhesive strip is anchored, magnets, hook-and-loop fasteners, places where pegs stick out, or anything else to help attach the pad 15 to the sheet of material 20.

The pads 15 may also provide feedback to the user 10 to help the user 10 make sure the platform is properly placed onto the pads 15. This feedback could be tactile, such as a going over a bump to get onto the column 31, or it could be an auditory or visual feedback provided by the pad 15, the display device 13, or both. This feedback is particularly advantageous to wheelchair users 10 using the scale 12 who may not be able to look at the wheels 14 of the wheelchair 11 to check if they are properly placed on the pads 15.

The pads 15 may also have features that make them easy to move around during the configuration process. This could include a strap or loop of fabric to make the pads 15 easier to grab for people with physical disabilities. It could include a clip so that wheelchair users 10 could clip the pads onto their wheels 14 at the top of the wheels 14, then roll the wheels 14 such that the pads 15 are under the wheels 14.

Turning to FIG. 4, positioned within the illustrated pad 15 are a rigid plate 40, a flexible pressure vessel 41, a pressure sensor 42, and a printed circuit board 43. The illustrated pressure sensor 42 and printed circuit board 43 are arranged within the electronics housing 34 and sealed from outside elements by a seal 44.

The rigid plate 40 is part of the column 31 and aids in transferring the load to the load sensor. The accuracy of the pressure-based pads 15 is dependent on the rigid plate 40 having constant area contacting the flexible pressure vessel 41. The rigid plate 40 must be made out of a material stiff enough to prevent bending, because bending would change the contact area and lead to inaccuracy of the scale measurement. The rigid plate 40 rests on top of the flexible pressure vessel 41, which is attached to the pressure sensor 42 such that the fluid or air in the system does not leak.

The pads 15 may use any mechanism for weighing, including strain gauges, a pneumatic system with non-compressible or compressible fluid, or capacitive plates. The pads 15 that the user rolls onto are advantageously thin (less than 0.75 inch thick) and make it easier for the user 10 to roll, place, or otherwise move the wheelchair 11 or other platform onto the scale 12. Keeping the pads 15 smaller also helps reduce the overall bulk and weight of the scale 12, and makes the scale 12 easier to manipulate, which makes storing or moving the scale 12 easier for the user 10. The ease of storage and movement of the scale 12 is especially important for users with physical disabilities, who may have more difficulty manipulating and transporting them than the general population. The size can be kept to a minimum by keeping the pads 15 thin and by reducing the electrical components in each pad 15 by moving functions like conversion, averaging, filtering, or display to the display device 13, rather than having these functions done by the sheet of flexible material 20 or the pads 15.

In these images the pads 15 are positioned on and attached to a sheet of flexible material 20 to hold them in place, although the pads 15 can also be used without the sheet 20 or can be used on the sheet but without being attached to the sheet 20. The pads 15 can be attached to the sheet 20 through any method of attachment (e.g., attachment element 45), including plastic rivets, hook-and-loop fasteners, tape, glue, friction, magnets, or pegs, so long as they will not be accidentally shifted or moved during use and will instead maintain the chosen configuration. Attaching the pads 15 to the flexible sheet 20 allows the whole scale 12 to be manipulated for storage without changing the configuration. Thus if the scale 12 is being used for only one platform, it can be easily stored or transported without the need to reconfigure the scale 12 each time, saving time and effort and increasing independence for the user 10. This is especially advantageous to users 10 with a physical disability that may make configuring the scale 12 especially difficult.

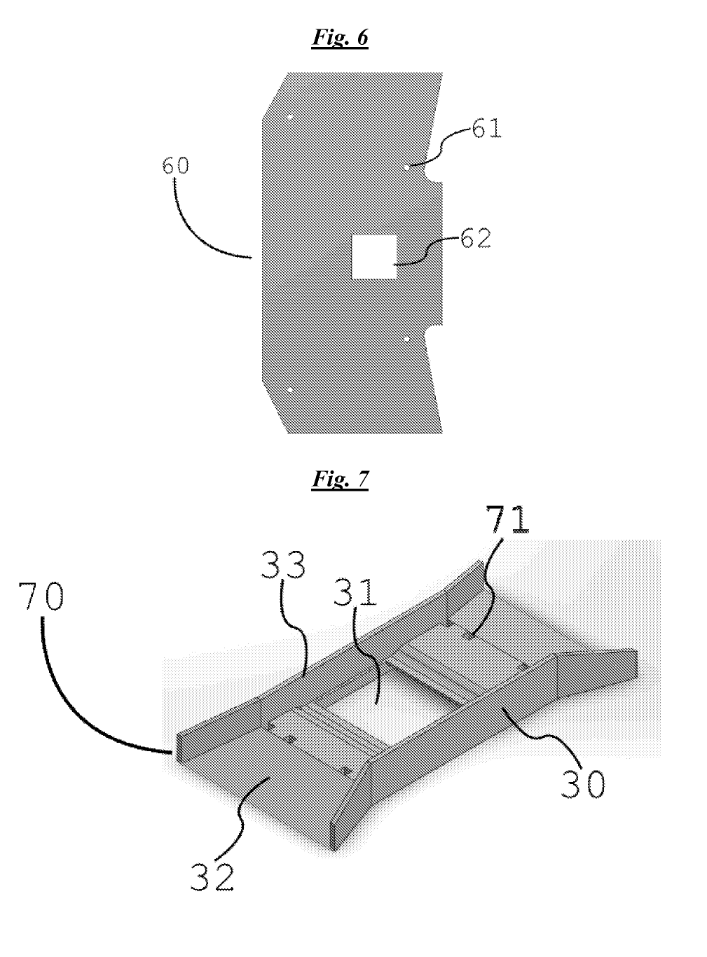

This attachment process could be made easier through the use of a template 60 as shown in FIG. 6, which can be shaped to match the layout of a pad and can thus more easily indicate where holes must be made or hook-and-loop fasteners attached in order to have a pad 15 in a certain location on the sheet 20. The attachment process could also be made easier through the use of a placeholder 110 (See FIG. 11), a 3-dimensional object that could be placed on the mat such that the pad 15 clips into it or otherwise gets attached. This would allow the configuration to be maintained even if a pad 15 needs to be removed for any reason, for example to replace a battery or to share pads 15 among multiple users 10.

The same scale 12 can be used with multiple different users 10 or platforms possibly by using multiple sheets 20 with different marked configurations, different configurations of attached placeholders 110, or by reconfiguring the pads 15 on the same sheet 20. This could be useful, for example, for a visiting physician who wishes to use the scale 12 with multiple patients who use different wheelchairs. Configurations could be marked on the sheet 20 using masking tape, markers, or any other method. Methods that allow multiple configurations to be marked at once on the same sheet 20 may be preferred so that the sheet 20 can be shared, and methods that are removable may be preferred for aesthetic reasons.

The pads 15 could contain the necessary parts to measure, compute, and wirelessly transmit weight data, or they could be connected to other parts of the scale 12, such as a central electronics box, that perform some or all of these functions. Information could be transmitted through wires, which could be free or embedded in the mat, or information could be transmitted wirelessly via any method including Bluetooth, WiFi, or cellular telephone signals. Transmitting information via Bluetooth has the advantages of working well at close distances, interfacing well with modern smartphones, being low cost, and using little power. Pads 15 could be powered by any energy source, including an external power source like a wall outlet, or by internal batteries, which could be rechargeable or non-rechargeable. Self-contained batteries or wireless power transfer provide the advantage of reducing external wires or connections that can tangle or interfere with the use of the scale 12. The pads 15 may contain their own calibration information used to calculate weight from a measurement, or that information may be stored externally, for example by the display device 13 or on the internet such that the display device 13 can access it.

The sheet 20 can be made of any durable and/or flexible material like rubber, fabric, vinyl, leather, elastomer foams, wood (e.g., a hinged plywood sheet), or bamboo mats. A sheet made from a flexible and durable material is preferred because the flexibility allows the sheet 20 to be rolled up or folded for storage, possibly with the pads 15 still attached, and the durability allows it to be rolled up or folded, moved, and used many times without deteriorating. A rubber material similar to that used for yoga mats is advantageous for the sheet 20 because it provides good grip between the sheet 20 and the floor as well as between the sheet 20 and the pads 15. This will help keep the sheet 20 from bunching up when wheels are rolled over it and will help keep the pads 15 from moving during use. A less squishy sheet 20, such as a tough rubber or a thin fabric, can improve accuracy by keeping the pads 15 from tilting if a load is applied off-center and the pad technology needs weight to be focused on the center of the pad. The sheet 20 may also have images or pictures on it, such as a grid, indications for where to place the pads 15, or logos. These images may assist in the configuration of the scale 12. The sheet 20 may also have holes, additional parts, or other physical modifications to assist with configuration, rolling, moving, or storage. Some examples of potential physical modifications to the sheet 20 include a hook-and-loop fastener strap to keep it rolled up, plastic pegs in a set configuration in the mat to attach to pads 15, or a small loop or handle to assist with being picked up or moved. The sheet 20 should be large enough to encompass the footprint of the user's platform. In the case of most manual wheelchairs 36″×36″ is enough, but these dimensions may need to be larger to accommodate electric wheelchairs or electric scooters.

Another pad 15′ is shown in FIG. 5. Two weight measurement mechanisms, in this case strain gauge devices 50, form the guiding ridges 33′ which guide a platform onto the column 31′. The column 31′, instead of being directly on top of the weighing mechanism, is attached to the strain gauge devices 50 on each side, and then descends to form a basket-like shape. This way the part of the column 31′ on which the platform is placed is kept as thin as possible, keeping it easy to roll or place a platform. This design could be used with weighing methods other than strain gauges. For instance, it could have a pneumatic weighing device on either side instead.

Turning to FIG. 6, the template 60 that could be used to mark or modify a sheet 20 to prepare it for attaching pads 15. This template 60 could have holes 61 corresponding to the attachment element 45 on a pad 15. These holes 61 can then help direct the user 10 configuring the scale 12 where to mark or make holes or attach parts to help attach the pads 15. Instead of holes the points could instead be tools for piercing the sheet 20 such that holes are made in the proper place for attachment. The template 60 could also have a window 62 that corresponds to where the column 31 or another relevant part of the pad will be to help the person configuring the scale 12 place the template 60 in the correct place.

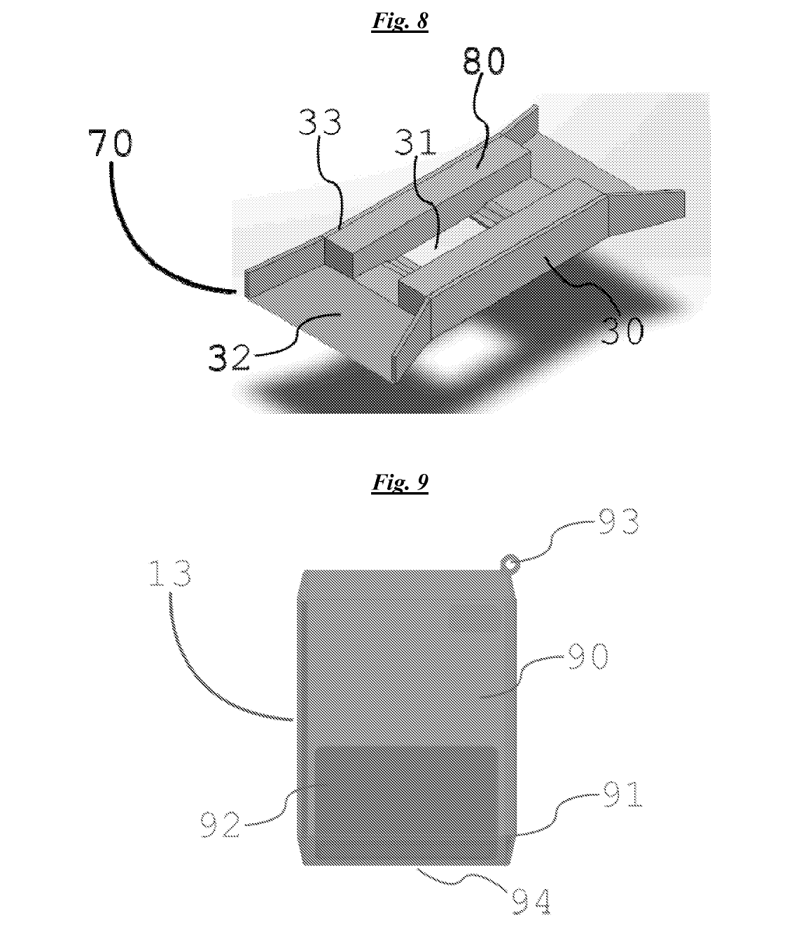

In FIGS. 7 and 8 there is shown a configurable pad design 70. Since pads 15 are more accurate for some weighing technologies when the load is properly centered over the pad 15, it is advantageous to have a pad 15 that aids the user 10 in centering the leg or wheel 14 of the platform on the pad 15. In addition to the pad components shown in FIGS. 3 and 4, the configurable pad 70 has slots 71 for spacers 80. The spacers 80 are added to reduce the available width to match the width of the wheel 14 or peg of the platform. The spacers 80 can be made out of any solid material, such as wood, plastic, metal, an inflatable pressure vessel, compressible foam, or rubber. If the spacers 80 are rigid they can be made hollow to reduce weight and material use, but it is not necessary for their operation. Other mechanical designs to achieve the same result can also be used, including spacers that slide and are locked into place by friction, pegs, or some other attachment method.

In FIG. 9 there is shown an example display device 13. The display device 13 may include a screen 90 which displays the weight visually, a speaker 91 for an audio output if desired by the user 10, and at least one button 92 which the user uses to query weight. The display device 13 can also include a loop or handle 93 to help the user 10 to pick up or hold on to the display device 13. The display device 13 can also include additional buttons, switches, or menus to help the user 10 change options or settings, such as taking a tare weight, changing the units, or creating and managing a profile that stores a specific tare weight or other information for a specific user or group of users. The display device 13 could also have a mounting mechanism 94 to attach it to a wall or part of the platform 11, such as the arms or back of a wheelchair. A mounting mechanism 94 could be advantageous for people who may not prefer to or may not be able to hold the display device 13.

Much of the computational work of the scale 12 can be allocated to the display device 13, thereby saving cost and bulk in the pads 15, which then may not require electronic components capable of doing complex computation. This computational work can include filtering the weight data, averaging the weight data, storing weight data, displaying aggregate weight data (e.g. as a graph of weight over time), storing user information as a profile, determining the correct user profile, alerting the user 10 if a particular event happens, a pad 15 is damaged or needs the battery replaced, or a goal is reached, or communicating with the internet or other applications on the display device 13.

The ability to have multiple profiles may be especially useful for doctors or nurses that may use the same scale 12 with multiple users 10, or for users 10 who may be sharing the scale 12. Being able to determine the correct profile based on matching weight or based on an ID associated with a particular sheet 20 reduces the burden on the user 10.

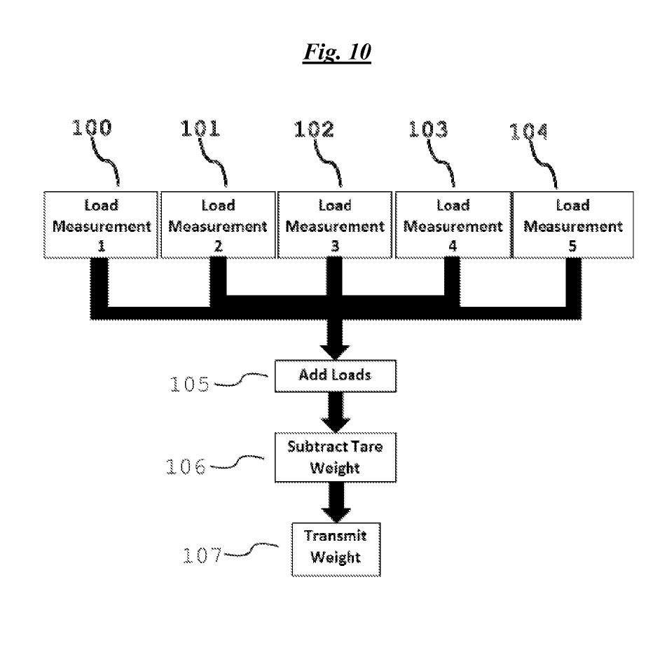

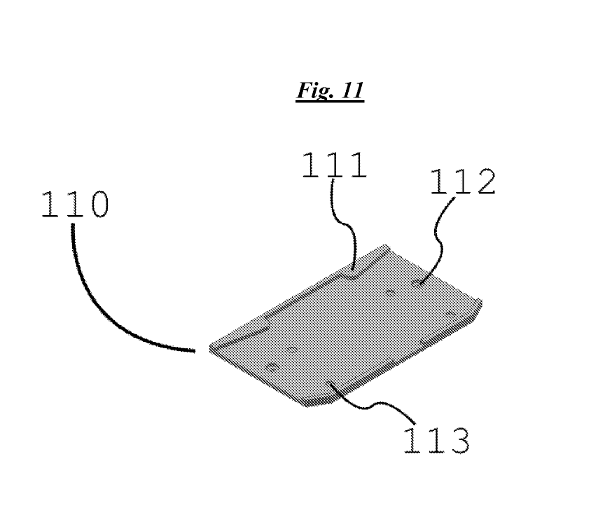

The flowchart in FIG. 10 describes the process of reading weight measurements from each pad 15 and sending a weight value to the display device 13. In step 105, the measured weights from each pad 15 (calculated in steps 100-104) are added together. In the chart, there are five pads 15 that calculate weight, and all five are added together. For any number of pads 15, all of the weights would be added together to calculate a total weight.

In step 106, the scale 12 subtracts the previously measured weight of the platform being used (e.g., the wheel chair 11), the weight of which is known as the tare weight. This step may or may not be used. This could be a weight that is known and is an input from the user 10, or it could be a weight that is measured and then stored by the scale 12. If this function is not needed, the tare weight may be the weight reading when there is no load on the scale 12. The resulting measurement is the weight of the subject (e.g., user 10, an animal, or another object) being weighed, which may be transmitted (at step 107) wirelessly or through wires to a phone, computer, or other remote device (e.g., the display device 13). The phone, computer, or other remote device may then transfer that information to the internet, to display on websites or applications such as www.facebook.com or a website or application used to monitor weight or aggregate health data over time, or to another person, such as the user's doctor.

In FIG. 11 there is shown an example placeholder design. The placeholder 110 is composed of walls 111, which securely hold the pad 15 in the placeholder without letting it slide or move. The placeholder 110 is attached to the sheet of flexible material 20 through a secure and semi-permanent attachment 112, which could be a rivet, magnets, hook-and-loop fasteners, tape, a bolt, or any other attachment method. The pad 15 can then be secured in the placeholder 111 through a non-permanent attachment 113, which could be magnets, hook-and-loop fasteners, a click fitting, or any other repeatable non-permanent attachment. This allows a user 10 to easily and conveniently share a set of weighing pads 15 with multiple different configurations on different sheets 20. Placeholders 110 with a more permanent attachment to the pad 15 may be used for scales that are only used by a single user.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

We claim:

1. A scale for measuring the weight of a subject associated with a personal mobility system, the scale comprising:
a sheet sized to receive the subject and the personal mobility system;
a plurality of weighing pads separate from and selectively engageable with the sheet in a pattern corresponding to the personal mobility system; and
a display device in communication with the weighing pads to display a weight of the subject or subject and personal mobility system.

2. The scale of claim 1, wherein the sheet is formed of a durable, flexible material.

3. The scale of claim 1, wherein the sheet is arranged to be at least one of rolled up and folded.

4. The scale of claim 1, wherein the sheet is about thirty-six inches square.

5. The scale of claim 1, wherein the sheet includes a non-slip surface arranged to inhibit slippage relative to a floor surface supporting the sheet.

6. The scale of claim 1, wherein each weighing pad includes:
an electronics housing,
a controller arranged within the electronics housing and in communication with the display device,
a load sensor in communication with the controller,
a column coupled to the electronics housing, arranged above the load sensor, and configured to substantially center a respective portion of the subject or the personal mobility system over the load sensor and transfer the load to the load sensor,
a ramp coupled to the column and arranged to facilitate rolling access to the column, and
an attachment element arranged to releasably couple the weighing pad to the sheet.

7. The scale of claim 6, wherein each weighing pad further includes guide rails that aid in centering the uniform load on the column.

8. The scale of claim 6 wherein the attachment element includes at least one of holes into which a push rivet or adhesive strip is anchored, magnets, hook-and-loop fasteners, and pegs protruding from the weighing pad.

9. The scale of claim 1, wherein the display device is in wireless communication with the plurality of weighing pads.

10. The scale of claim 1, wherein the display device includes a processor configured to receive feedback from the plurality of weighing pads and to determine therefrom the weight of the subject or subject and personal mobility system.

11. The scale of claim 10, wherein the processor is configured to perform a filtering of the feedback, average the feedback data, store the feedback data, generate aggregate weight data from the feedback data, store user information as a profile, determine a user profile, alert a user if a predetermined event occurs, alert the user if a goal is reached, and communicate with the internet and other applications on the display device.

12. The scale of claim 1, wherein the display device is includes a mobile computing device.

13. The scale of claim 1, wherein the sheet includes a pattern formed thereon and configured to aid a user in arranging the weighing pads on the sheet.

14. The scale of claim 13, wherein the pattern includes holes corresponding to an attachment element on the weighing pad.

15. The scale of claim 1, further comprising a plurality of placeholders coupled to the sheet in multiple configurations and arranged to receive the plurality of weighing pads.

16. The scale of claim 1, wherein the sheet further comprises a plurality of electrical power connections distributed therethrough and configured to supply operational power to the plurality of weighing pads when engaged with the sheet.

17. A weighing pad for use in a portable, adjustable, scale system including a plurality of the weighing pads to determine a weight of a subject associated with a personal mobility system and communicate the weight to a display device, the weighing pad comprising:
an electronics housing;
a controller arranged within the electronics housing and configured to communicate with the display device;
a load sensor in communication with the controller;
a column coupled to the electronics housing and arranged to substantially center the subject or a portion of the subject and the personal mobility system the over the load sensor and transfer the load to the load sensor; and
a ramp coupled to the column and arranged to facilitate rolling access to the column; and
an attachment element arranged to selectively couple the weighing pad to the sheet.

18. The weighing pad of claim 17, further comprising guide rails arranged to guide the subject onto the column and maintain the subject substantially centered on the column.

19. The weighing pad of claim 17, wherein the controller is arranged to wireless transmit data received from the load sensor.

20. A scale for measuring the weight of a subject sitting in a four wheel wheelchair, the scale comprising:
a sheet of flexible material arranged to lay flat on a floor surface and be manipulated into a storage arrangement;
four weighing pads separate from and selectively engageable with the sheet in a pattern corresponding to the four wheels of the wheelchair, each of the weighing pads independent of the other weighing pads and including
an electronics housing,
a controller arranged within the electronics housing,
a load sensor in communication with the controller,
a column coupled to the electronics housing, arranged above the load sensor, and configured to substantially center one of the wheels over the load sensor and transfer the load to the load sensor,
a ramp coupled to the column and arranged to facilitate rolling access to the column, and
an attachment element arranged to releasably couple the weighing pad to the sheet; and
a display device in communication with the controllers of the weighing pads to display a weight of the subject and the wheelchair.
